(19) United States
(12) Patent Application Publication
(10) Pub. No.: US 2019/0211594 A1
(43) Pub. Date: Jul. 11, 2019

(54) LATCHING STRUCTURE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU-CHUN SUN, New Taipei (TW); ZHAN-SHENG LU, Shenzhen (CN); ZE-MIN WU, Shenzhen (CN)

(21) Appl. No.: 15/927,196

(22) Filed: Mar. 21, 2018

(30) Foreign Application Priority Data
Jan. 9, 2018 (CN) 201820036881.6

(51) Int. Cl. E05C 19/06; E05C 19/10; E05C 19/00

(52) U.S. Cl. CPC E05C 19/063; H01M 2/1016; E05C 19/007; E05C 19/10

(57) ABSTRACT

A spring-loaded rounded latching structure includes a main body and a back cover. The main body defines a groove bound by a bottom wall and a sidewall. The bottom wall defines a slot and includes a resisting portion. The side wall includes a first snap. The main body includes a button. The button includes a pushing member. The back cover defines a second slot and includes a second snap and a stopping block. The back cover is slidable relative to the main body along the groove defined in the main body. The first snap is snapped in the second slot. The second snap is snapped in the first slot. The resisting portion resists the stopping portion to limit a sliding movement of the back cover. The resisting portion is released from the stopping portion within the groove by the pushing member.

### FIELD

The subject matter herein generally relates to latching structures, and more particularly to a robotic latching structure.

### BACKGROUND

Generally, assembly of electronic devices involves latching a cover to a main body of the electronic device. Electronic devices having rounded surfaces require a more complicated structure for latching the cover to the main body.

### BRIEF DESCRIPTION OF THE DRAWINGS

Implementations of the present disclosure will now be described, by way of example only, with reference to the attached figures.

FIG. 1 is an exploded, isometric view of an exemplary embodiment of a latching structure in accordance with an embodiment of the present disclosure.

FIG. 2 is a side view of the latching structure.

FIG. 3 is another side view of the latching structure.

FIG. 4 is a side view of FIG. 2.

FIG. 5 is another side view of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

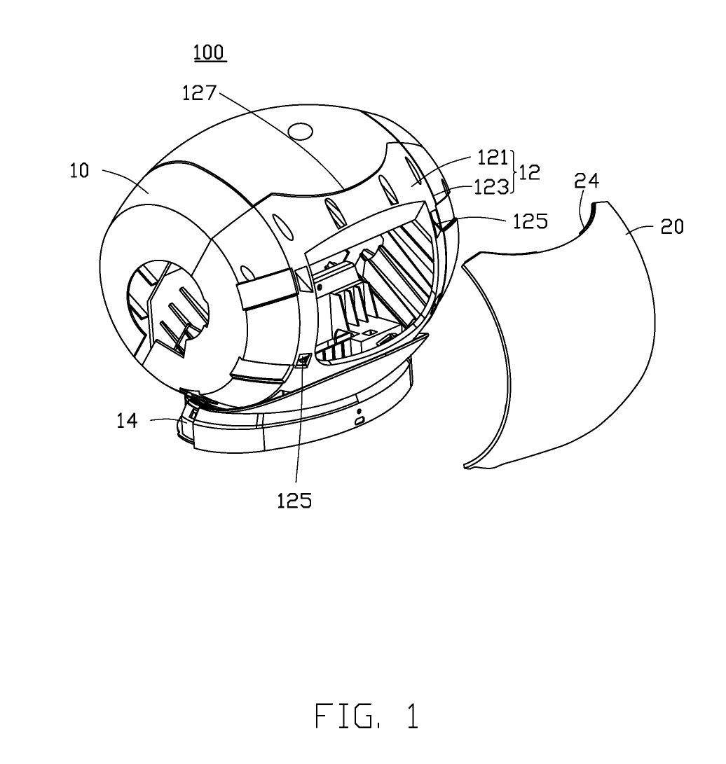

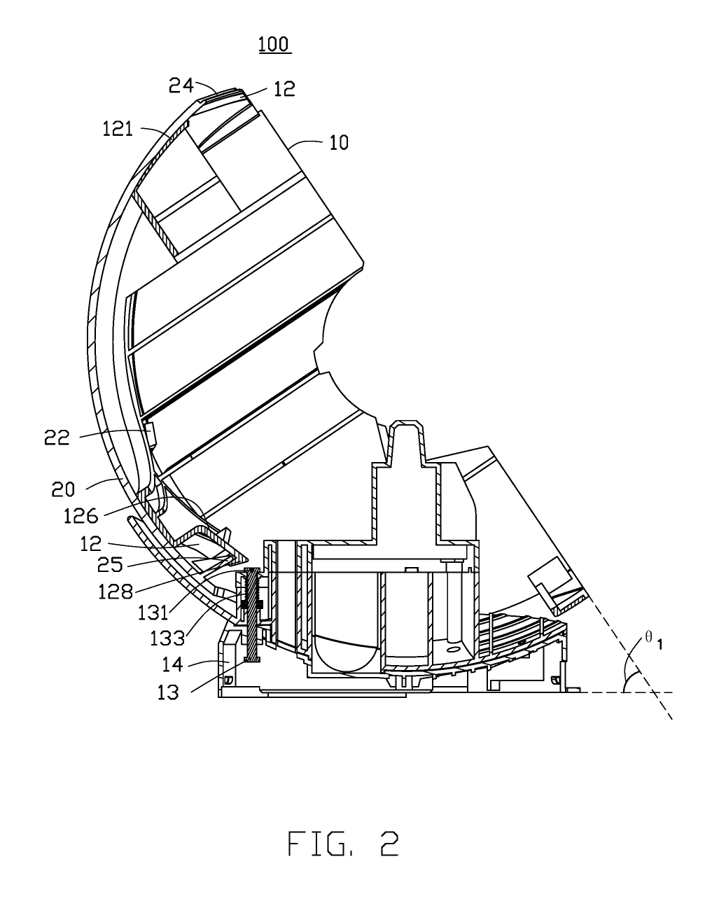

FIG. 1 and FIG. 2 illustrate an embodiment of a latching structure 100. The latching structure 100 includes a main body 10 and a back cover 20. A groove 12 is defined in the main body 10. The main body 10 includes a button 13 (shown in FIG. 2). The groove 12 is bound by a bottom wall 121 and a sidewall 123. The sidewall 123 extends from the bottom wall 121. The bottom wall 121 defines at least one first slot 125 and includes a resisting portion 126 (shown in FIG. 2). The sidewall 123 includes a first snap 127. The back cover 20 includes at least one second snap 22 and a stopping block 25 (shown in FIG. 2) and defines a second slot 24. The back cover 20 is slidable relative to the main body 10 through the groove 12 to snap the first snap 127 and the second snap 22 in the second slot 24 and the first slot 125, respectively.

The resisting portion 126 and the stopping block 25 cooperatively limit a sliding movement of the back cover 20. The button 13 includes a pushing member 131. The pushing member 131 can release the limiting portion 126 from limiting the back cover 20 in the groove 12. In at least one embodiment, the groove 12 is defined in an outer surface of the main body 10. The bottom wall 121 and the back cover 20 have a same curvature so that the back cover 20 can snap to the bottom wall 121. A quantity of the first slot 125 is the same as a quantity of the second snap 22, and a position of the first groove 125 on the bottom wall 121 corresponds to a position of the second snap 22 on the back cover 20. The sidewall 123 surrounds the bottom wall 121 on the main body 10. The first snap 127 is arranged at an upper portion of the sidewall 123, and the second slot 24 is arranged at an upper portion of the back cover 20. Thus, when the back cover 20 is snapped to the bottom wall 121, the first snap 127 can snap in the second slot 24.

Referring to FIG. 2, the main body 10 includes a base 14. The base 14 is rotationally coupled to the main body 10. The button 13 is arranged on the base 14. The pushing member 131 extends into the groove 12 of the main body 10. A resilient member 133 is arranged between the pushing member 131 and the button 13. The resilient member 133 causes the pushing member 131 to be adjacent to the base 14 within the groove 12. Pushing the pushing member 13 causes the pushing member 131 to protrude into the groove 12. Thus, the pushing member 13 controls extension of the pushing member 131 within the groove 12. When the main body 10 and the base 14 define a first angle, the pushing member 13 and the resisting portion 126 are staggered relative to each other, and the bottom wall 121 defines an angle with the back cover 20 snapped to the bottom wall 121.

In assembly, in the first angle, the back cover 20 is aligned in the groove 12, and the resisting portion 126 and the stopping block 25 limit a sliding movement of the back cover 20. The resisting portion 126 and the stopping block 25 prevent the back cover 20 from sliding along the groove 12 to the corresponding position for snapping the back cover 20 to the bottom wall 121.

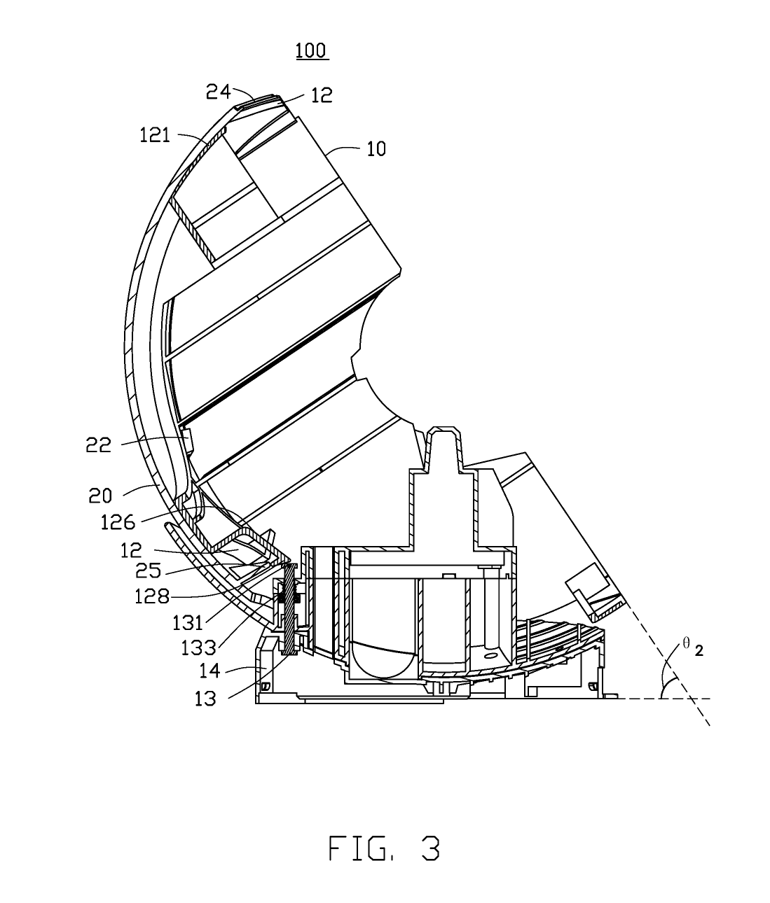

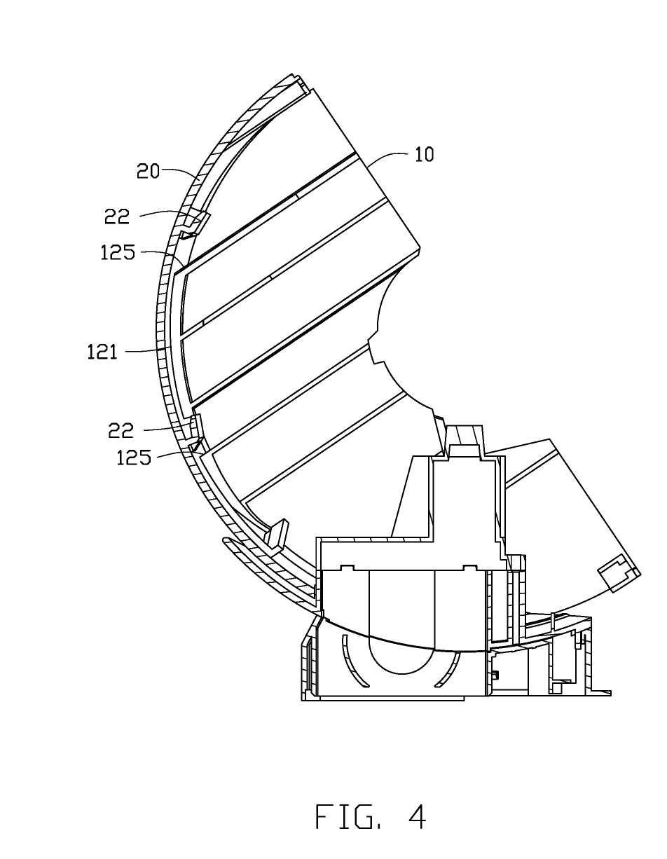

Referring to FIG. 3, in order for the second snap 22 to snap in the first slot 125, the main body 10 must be rotated to release the resisting portion 126 from limiting the back cover 20. In at least one embodiment, the base 14 supports the main body 10, and the main body 10 rotates relative to the base 14. When the main body 10 defines the first angle, the main body 10 can be rotated. When the main body 10 is rotated such that the main body 10 and the base 14 define a second angle, the resisting portion 126 and the pushing member 131 are aligned with each other. The resisting portion 126 is a resilient hook extended toward the base 14 from the bottom wall 121. A hook 128 is formed at an end of the resisting portion 126. The hook 128 protrudes toward a side surface of the bottom wall 121. The pushing member 131 pushes the hook 128 to cause the resilient portion 126 to extend again. The back cover 20 is released from being limited when the resilient portion 126 extends again after being pushed by the pushing member 131. After the back cover 20 is released, the back cover 20 can slide toward the base 14 to the corresponding position relative to the bottom wall 121, and the second snap 22 is snapped in the first slot 125 (shown in FIG. 4). Both the first angle and the second angle are defined by the main body 10 and the base 14. The second angle is smaller than the first angle. In at least one embodiment, the first angle is 75 degrees, and the second angle is 61 degrees.

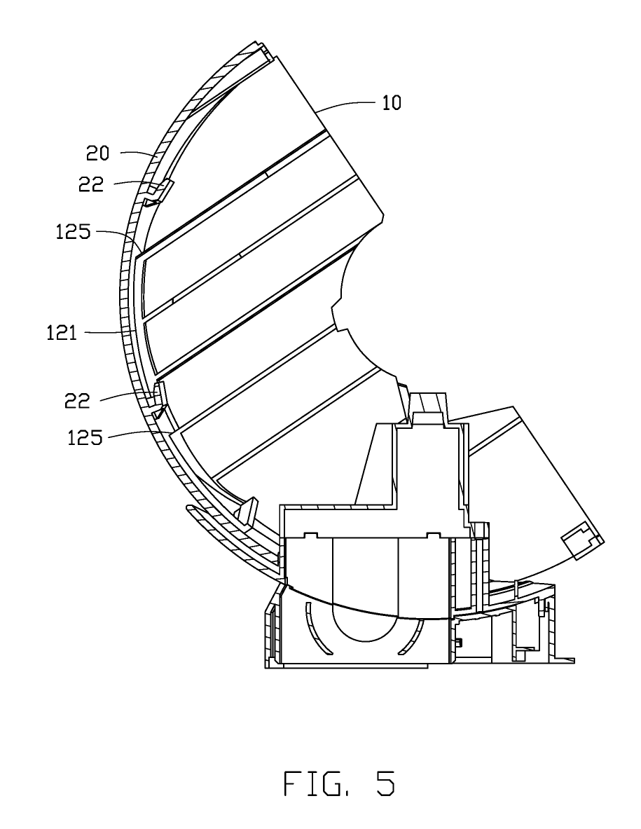

Referring to FIG. 5, after the second snap 22 is snapped in the first snap 125, the back cover 20 can slide away from the base 14 along the curvature of the bottom wall 121 to tighten the second snap 22 in the first slot 125, until the first snap 127 is snapped in the second slot 24. When the stopping block 25 follows the back cover 20 away from the base 14, the button 13 can be released, and the button 13 is restored to an original position by the resilient member 133. That is, the pushing member 131 is returned to be adjacent to the base 14 within the groove 12, and the resisting portion 126 and the stopping block 25 continue to limit movement of the back cover 20 to maintain the back cover 20 snapped to the bottom wall 121. After the back cover 20 is snapped to the bottom wall 121, the main body 10 is rotated to the first angle, such that the pushing member 131 and the resisting portion 126 are staggered (shown in FIG. 2). Thus, the button 13 can no longer release the resisting portion 126 from limiting the back cover 20, so that the back cover 20 is secure.

The latching structure 100 can be applied in an electronic structure or a shell of a robotic structure. Specifically, the main body 10 is a main body of a robot (not shown in figures). Assembly and disassembly of the back cover 20 to the bottom wall 121 are carried out at designated angles of the main body 10 relative to the base 14. Thus, assembly of electronic structures or robotic structures having rounded surfaces is improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A latching structure comprising:
a main body defining a groove bound by a bottom wall and a sidewall, wherein the bottom wall defines a slot and comprises a resisting portion, the side wall comprises a first snap, the main body comprises a button, the button comprises a pushing member; and
a back cover defining a second slot and comprising a second snap and a stopping block, wherein the back cover is slidable relative to the main body along the groove defined in the main body, the first snap is snapped in the second slot, the second snap is snapped in the first slot, the resisting portion resists the stopping portion to limit a sliding movement of the back cover, the resisting portion is released from the stopping portion within the groove by the pushing member.

2. The latching structure of claim 1, wherein the main body comprises a rotatable base for supporting the main body thereon; the button is on the rotatable base; the pushing member of the button passes through the groove of the main body.

3. The latching structure of claim 2, wherein the button comprises a resilient member; the pushing member is adjacent to the base and passes through the groove; pushing the button causes the pushing member to protrude into the groove; the button controls extension of the pushing member within the groove.

4. The latching structure of claim 1, wherein when the base and the main body define a first angle, the pushing member and the resisting portion are staggered relative to each other, and the bottom wall defines an angle with the back cover snapped to the bottom wall.

5. The latching structure of claim 4, wherein when the main body is rotated until the base and the main body define a second angle, the resisting portion is aligned with the pushing member; the second angle is smaller than the first angle.

6. The structure of claim 1, wherein the bottom wall and the back cover have a same curvature; a quantity of the first slot is the same as a quantity of the second snap; a position of the first slot on the bottom wall corresponds to a position of the second snap on the back cover.

7. The structure of claim 1, wherein the first snap is arranged at an upper portion of the sidewall; the second slot is defined in an upper portion of the back cover; after the back cover is snapped to the bottom wall; the back cover is caused to slide upward along the groove to align the second slot to the first snap and to tighten the second snap in the first slot.

8. The latching structure of claim 1, wherein the resisting portion is a resilient hook extended from the bottom wall toward the base; an end portion of the resilient hook is a hook protruded toward a side surface of the bottom wall.

9. The latching structure of claim 8, wherein when the hook is aligned with the pushing member and the pushing member pushes the hook, the resilient hook rebounds to cease limiting the back cover in the groove.

10. A robotic latching structure comprising:
a robot main body defining a groove bound by a bottom wall and a sidewall, the bottom wall defines a slot and comprises a resisting portion, the side wall comprises a first snap, the main body comprises a button, the button comprises a pushing member; and
a back cover defining a second slot and comprising a second snap and a stopping block, the back cover is slidable relative to the main body along the groove defined in the main body, the first snap is snapped in the second slot, the second snap is snapped in the first slot, the resisting portion resists the stopping portion to limit a sliding movement of the back cover, the resisting portion is released from the stopping portion within the groove by the pushing member.
